(19) United States
(12) Patent Application Publication
(10) Pub. No.: US 2018/0298457 A1
(43) Pub. Date: Oct. 18, 2018

(54) SYSTEMS AND METHODS FOR PRODUCING SYRUPS AND POWDERS FROM SUGAR CANE USING COLD TECHNOLOGY AND PRODUCTS CONTAINING SAME

(71) Applicant: Whole Cane, Bellingham, WA (US)

(72) Inventors: Jeremiah Ridenour, Bellingham, WA (US); Timothy Ridenour, Bellingham, WA (US)

(21) Appl. No.: 15/944,664

(22) Filed: Apr. 3, 2018

Related U.S. Application Data
(60) Provisional application No. 62/484,724, filed on Apr. 12, 2017.

(51) Int. Cl. C13B 10/02; C13B 5/04; C13B 25/04; C13B 20/16

(52) U.S. Cl. CPC C13B 10/025; C13B 20/16; C13B 25/04; C13B 5/04

(57) ABSTRACT

Systems, apparatuses, and methods for producing and using a sugar cane syrup, juice, or powder. In one embodiment, the invention is directed to a system and associated processes for processing sugar cane using a cold processing pipeline in a manner that retains its natural nutritional value while producing a syrup, juice, or powder without significant separation of the natural nutrients or use of harmful chemicals.

### CROSS REFERENCE TO RELATED APPLICATIONS

This application claims the benefit of U.S. Provisional Application No. 62/484,724, entitled “Systems and Methods for Producing Nutraceutical Syrups and Powders from Sugar Cane and Sugar Beets Using Cold Technology and Products Containing Same,” filed Apr. 12, 2017, which is incorporated by reference herein in its entirety (including the Appendix) for all purposes.

This application includes the attached Appendix, which contains information that may provide further examples and/or details regarding one or more embodiments of the invention described herein. The entire contents of the Appendix are considered part of the present application and are incorporated herein in its entirety.

### BACKGROUND

Sweetening agents are used in a wide variety of products, typically to enhance the taste or functionality (for example, the viscosity) of the product. Such products include foods, candies, medicines, beverages, drugs, etc. However, presently available sweetener choices derived from conventionally used feedstock such as sugar cane (Saccharin officinarum L.), sugar beets, or corn offer nothing except calories in terms of nutritional content, as they are primarily highly refined carbohydrates. This presents a health problem, as research suggests that the over-consumption of refined sugars is a strong factor in the growth of diabetes, obesity, and cardiovascular disease, among consumers. Both of these conditions are at epidemic or near epidemic proportions worldwide; for example, 9.4% of the US population has been diagnosed with such conditions/diseases (with 235,000 deaths per year attributed to these diseases), and with younger and younger people being diagnosed with type I and type II diabetes every year as they adopt the consumption habits of their parents.

As recognized by the inventors, this (near) epidemic is at least partially the result of the processing methods and standards used in commercial sugar production. These include heating, chemical stripping and refining natural sugar juice to create the sweetening agents used in foods and beverages. These sugars have little or no nutritional value and a relatively high glycemic index (GI). Note that fructose, a common sweetening agent, has been identified as one of the most detrimental sugars for human consumption, as it does not trigger the insulin response and is one of the main factors that produces fat in the liver (and the consumption of which is believed to be one of the main factors leading to obesity). In fact, research suggests that consumption of high-fructose corn syrup in beverages may play a role in the epidemic of obesity (George A Bray Samara Joy Nielsen Barry M Popkin, The American Journal of Clinical Nutrition, Volume 79, Issue 4, 1 Apr. 2004, Pages 537-543, https://doi.org/10.1093/ajcn/79.4.537, Published: 1 Apr. 2004).

For example, the conventional method of processing sugar cane to produce refined sugars leaves white cane sugar as pure sucrose in a final product devoid of significant nutritional content that is beneficial for the body. Instead, the naturally occurring nutritional antioxidants, minerals, and vitamins are removed and accumulated as Molasses, a by-product of the conventional process. Note that based on USDA (2016), Molasses includes many beneficial macro and micronutrients, including Vitamin B complex, as well as trace minerals such as Iron, Magnesium, Potassium, all of which are removed or chemically refined out of the sugar products produced by conventional processing methods, as shown in the Table below:

| | | Value per |
|---|---|---|
| | Unit | 100 g |
| Nutrient | | |
| Water | g | 21.87 |
| Energy | kcal | 290.00 |
| Protein | g | 0.00 |
| Total Lipid | g | 0.10 |
| Carbohydrate, by | g | 74.73 |
| difference | | |
| Fiber, total dietary | g | 0.00 |
| Sugars, Total | g | 74.72 |
| Minerals | | |
| Calcium | mg | 205.00 |
| Iron | mg | 4.72 |
| Magnesium | mg | 242.00 |
| Phosphorus | mg | 31.00 |
| Potassium | mg | 1464.00 |
| Sodium | mg | 37.00 |
| Zinc | mg | 0.29 |
| Vitamins | | |
| Vitamin C, total ascorbic | mg | 0.00 |
| acid | | |
| Thiamin | mg | 0.0041 |
| Riboflavin | mg | 0.0020 |
| Niacin | mg | 0.9300 |
| Vitamin B-6 | mg | 0.6700 |
| Folate, DFE | μg | 0.00 |
| Vitamin B-12 | μg | 0.00 |
| Vitami A, RAE | μg | 0.00 |
| Vitamin A, IU | IU | 0.00 |
| Vitamin E (alpha- | mg | 0.00 |
| tocopherol) | | |

USDA Standard Reference: Molasses (USDA, 2016)

As indicated by the Table (above), the Molasses by-product from the conventional process contains a significant amount of nutrients which have been removed from the final refined sugar product. Further, in conventional sugar cane processing, the processing steps that are applied are unable to preserve the majority of the Polyphenol content (such as Flavonoid and Phenolic Acid that function as beneficial antioxidants) due to an enzymatic browning reaction that occurs soon after the cane is harvested. Note that enzymatic browning is one of the major causes of deleterious changes in the sensory properties of the product, thereby limiting its storage for a longer time. Browning also causes other issues that may affect the antioxidant function of the product, due to it oxidizing the Polyphenol content into 0-Quinones that no longer have the molecular form that supports the anti-oxidant function. This is because when phenols are oxidized to form quinones, the reaction involved is a reversible reaction in that up to the stage of Quinone, the process is reversible. But if the oxidation process proceeds, it connects the individual phenol molecules between themselves and results in an oxidative condensation with the formation of polymeric products. At this later stage of molecular condensation, the antioxidant potential of the individual components is lost.

Embodiments of the system and methods described herein are directed toward solving these and other nutritional problems individually and collectively through an innovative processing pipeline for sugar cane, and the incorporation of the resulting “Whole Cane” syrup, juice, or powder into multiple products and delivery systems without significant nutrient separation or removal. The result are products that the human body perceives as a “whole food” with its nutrients in their natural ratios to each other, and which travels through the digestive system minimizing blood sugar spikes and providing nutraceutical quality nutrition.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for producing and using a sugar cane syrup, juice, or powder. In one embodiment, the invention is directed to a system and associated processes for processing sugar cane in a manner that retains its natural nutritional value while producing a syrup, juice, or powder without significant separation of the natural nutrients. Further, it is believed by the inventor that the glycemic index (GI) of the resulting product or products achieves a low-to-medium GI rating, a value which would provide significant benefits to those seeking a relatively lower GI replacement for refined sugar. In other embodiments, the processes described herein may be used to produce a product that can be used as a sweetening agent in multiple products or items.

The benefits and advantages of the embodiments described herein are achieved (at least in part) by a processing pipeline that operates at a lower temperature (or temperatures) than a conventional processing pipeline and uses no harmful chemicals in the processing. To maintain the low temperatures necessary to retain maximum nutrients throughout the processing pipeline, in some embodiments, the inventive process includes the use of chilled water (or other coolant) circulating within a plate heat exchanger to maintain processing temperatures in the 2-4 C range to avoid nutrient deterioration. The inventive process also uses a “cold” product protection and shelf life extending stage or processing step that is not reliant on heating the end product of the pipeline to destroy harmful bacteria (as would conventional pasteurization processes). The resulting cane syrup or powder retains much of the nutritional value of the unprocessed sugar cane. In contrast to conventional processing pipelines for sugar cane, the cold process described herein leaves the nutrients intact and in their normal ratios to each other in the resulting juice, syrup and powder. This act of leaving the natural nutritional composition intact and in its natural ratios impacts how body digests the complete nutritional spectrum contained in the whole cane juice, syrup and powder, and treats it like a whole food rather than just pure concentrated sucrose (which spikes blood sugar and supports diabetes symptoms). Additional information regarding retention of bioactive compounds may be found in the paper entitled “The Effect of Extraction Temperature on Total Phenols and Antioxidant Activity of Gynura procumbens leaf”. This paper also provides information that the inventors considered when they determined a range of desirable processing temperatures (by indicating very little degradation of bioactive compounds in the range of 40 degrees C. to 50 degrees C.), with the inventors determining a desired range of 37-50 C as a target processing temperature.

In some embodiments, the invention is directed to providing an industrial sweetener for use in consumed products and which does not result in a spike in blood sugar; such uses include coffee sweetener, ice cream, yogurts, soft drinks, sports drinks, pastries, chocolate, cereals, etc. The nutraceutical composition of the sweetener may provide specific nutrients such as iron, potassium, or magnesium, in sufficient quantities to be able to make label or health claims for the product to which the output of the system and processing methods described herein was added in the form of a juice, syrup, or powder.

In other embodiments, the invention is directed to the development of products from the base juice, syrup, and powder that can be used to replace pure sucrose in end products used in the pharmaceutical, medical, and cosmetic industries; these products include elixirs, cough syrups, medicated and non-medicated syrups, and foods targeted to individuals with chronic conditions that need nutrition in a sweetened format.

In one embodiment, the invention is directed to a method for processing sugar cane, where the method includes:
soaking the raw cane in a first bio-acidifier solution prior to juicing;
juicing the soaked raw cane to produce raw cane juice;
conditioning the juice, brix 13-15 to a pH of between 3.8 to 4.5 by adding an amount of a second bio-acidifier solution;
passing the conditioned raw cane juice through a cooling component to reduce the temperature of the raw cane juice to between 2 and 4 degrees C.;
subjecting the cooled raw cane juice to an evaporation step, wherein the evaporation step temperature is maintained within a range of 37 to 50 degrees C. until the Brix value reaches 60-72 Brix;
subjecting the output of the evaporation step to a process to prevent degradation from microbiological activity; and
packaging the output of the product protection process.

In another embodiment, the invention is directed to a system for processing sugar cane, where the system includes:
a container for soaking the raw cane, the container including a first bio-acidifier solution;
a juicing element for juicing the soaked raw cane to produce raw cane juice;
a container for conditioning a pH of the raw cane juice, brix 13-15, to a pH of between 3.8 to 4.5 by adding an amount of a second bio-acidifier solution;
a cooling element operative to reduce the temperature of the raw cane juice to between 2 and 4 degrees C.;
an evaporator for subjecting the cooled raw cane juice to an evaporation process, wherein the evaporation process temperature is maintained within a range of 37 to 50 degrees C. until the Brix value reaches 60-72 Brix;
a processing element for protecting the output of the evaporator from degradation from microbiological activity; and
a packager for packing the output of the product protection process.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1(a) is a diagram illustrating elements or components of a conventional processing system and pipeline for producing refined white sugar from raw sugar cane;

FIG. 1(b) is a diagram illustrating the types of products that may be derived from the conventional processing of sugar cane;

FIG. 2 is a diagram illustrating elements or components of a system and pipeline for processing sugar cane in which an embodiment of the invention may be implemented; and

FIG. 3 is a chart which indicates aspects or stages of the conventional cane processing pipeline at which deterioration may occur.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

As mentioned, embodiments of the sugar cane processing pipeline described herein may be used to produce a syrup, juice, or powder that retain much (if not all) of the nutritional value that is removed from refined sugar products that are produced using a conventional processing pipeline. Furthermore, besides the beneficial nutrients noted in the previous Table, the products of the process described herein (i.e., juice, syrup, and powder) also contain Polyphenols, such as Flavonoid and Phenolic Acid that function as antioxidants.

Based on a study titled “Antioxidant Activity in Sugarcane Juice and its Protective Role Against Radiation Induced DNA Damage”, an ORAC test was conducted on three varieties of fresh sugarcane juice. The ORAC value of these 3 different varieties of Sugar cane are shown in a table from the study, which is reproduced below. The study reveals that sugarcane juice has the ability to scavenge free radicals, reduce iron complex and inhibit lipid peroxidation, and explains possible mechanisms by which sugarcane juice exhibits its beneficial effects in relation to its reported health benefits.

Note that the study was conducted using cane juice that has yet to go through the processing pipeline described herein. After that processing, the inventor expects to find much higher ORAC levels due to the cold evaporation process, which essentially concentrates the juice and raises the ORAC numbers reported above. In addition, because of the relatively low processing temperatures used, the inventor expects that most if not all of the original vitamins, minerals, antioxidants and other beneficial constituents will remain intact and beneficial. It is noted that ORAC value is a quantitative method of measuring the antioxidant activity of plasma, foods, natural extracts, etc., and has become a standard, although not a unique method over the last five years. ORAC values, in micromole TE, Trolox (a soluble analogue of Vitamin E, used as a standard) equivalents per 100 g for cane syrup are shown in the Table below:

TABLE 1
Total phenolic and flavonoid content of sugarcane juice and their
antioxidant activities measured by ORAC assay

| Sugarcane | Total phenolic | Total flavonoid | ORAC value |
|---|---|---|---|
| juice | content (mg GA | content (mg quercetin | (μmol TE/ |
| (varieties) | eq/ml juice)^{a} | eq/ml juice)^{a} | ml juice)^{b} |
| Co.C-419 | 631.5 ± 4.4 | 3.57 ± 0.03 | 16.35 |
| DSEM.Co.C-671 | 664.5 ± 3.9 | 4.88 ± 0.02 | 18.53 |
| Co.C-86032 | 402.3 ± 7.9 | 2.43 ± 0.04 | 23.64 |

GA eq- is gallic acid equivalent.
TE- is trolox equivalent.
^{a}Data expressed is mean ± standard error of four independent experiments.
^{b}Data expressed is of single experiment.

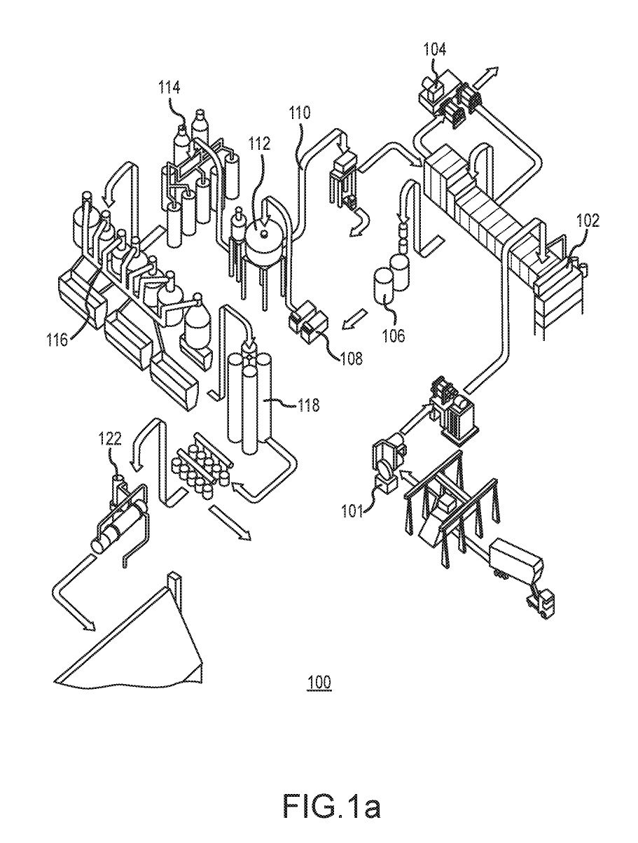

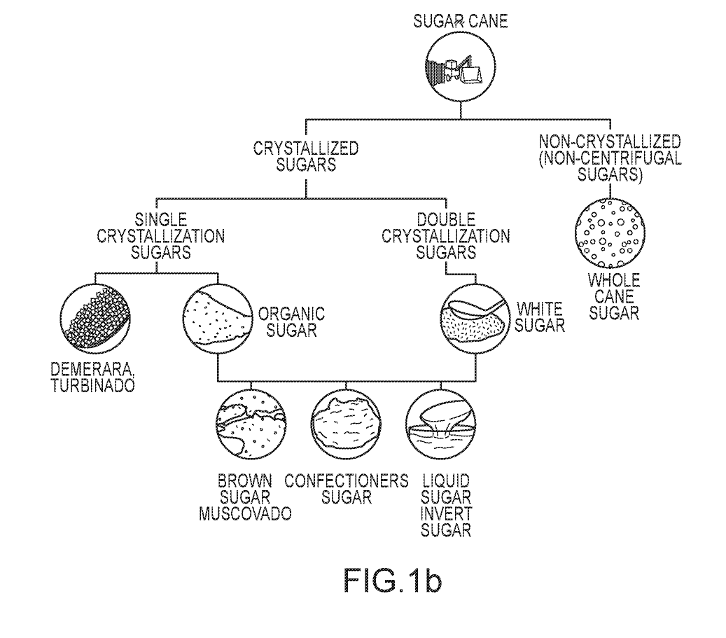

FIG. 1(a) is a diagram illustrating elements or components of a conventional processing system and pipeline 100 for producing refined white sugar from raw sugar cane. This set of processing steps or stages is typically used to produce a refined sugar product. As shown or suggested by the figure, the raw sugar cane from the fields is cut, collected, shredded (as suggested by 101), and introduced into a cleaning element, such as the diffuser 102 illustrated in the figure. In conventional systems and processing methods, the cane may be subject to the formation of reducing sugars, such as glucose and fructose, due to the delay between the harvesting and processing, and the heat added during processing.

The diffuser 102 is used to clean raw cane coming from the field and is heated to 70-80 degrees C. to remove field dirt and rocks, and to minimize bacteria. A dewatering mill or juicer 104 sends the juice back through the diffuser for re-heating before entering the juice weighing scale 106 in batches before going into the second heating phase, commonly termed “juice heating” 108. The cane juice is heated as flocculation chemicals, such as lime, bleaching agents or hydrolyzed polyacrylamides are added and organic sediments and insoluble minerals drop out of solution (i.e., they precipitate). These sediments and minerals, such as calcium or magnesium salts (which are unwanted in the refining process), drop out or flocculate and accumulate in what is termed “mill mud” 110 at the bottom of the juice-heating tank, where the flocculation process is performed at a temperature in the range of 80-100 degrees C.

Sugar cane mill mud has a composition that may include organic carbon, Nitrogen, Phosphorus, Potassium, Calcium, Magnesium, Sulphur, Copper, Zinc, Iron, Manganese, and Boron. The mill mud composition, which is due to the flocculation step in the conventional processing pipeline. Further, mill mud has an acidic pH in the range of 4-4.9, and contributes to the BOD (biological oxygen demand) and COD (chemical oxygen demand) load in the wastewater. This is damaging to available water supplies and causes contamination (which may require chemicals to remediate the problem at the municipal level).

Note that mill mud has traditionally been applied to the surrounding sugar cane fields to provide some soil nutrition, although the procedure of spreading mill mud back on cane fields is really dumping a slurry-like material that the local processor has no use for. The volume of mill mud may be significant, and the mud typically contains trace minerals and unwanted chemicals. Note that due to the volume of material and newer analysis of this practice, mill mud is now viewed as a potential soil contaminate and source of ground water and stream pollution. Note also that embodiments of the processing pipeline described herein effectively eliminate the production of mill mud.

The process or component referred to as the “clarifier” 112 in the Figure separates the mill mud and chemicals in a rotary filter and the clarified juice (which includes molasses) moves into the first evaporation stage 114. In making refined sugar, this evaporation is completed in double or triple effect evaporators with each one leading to the next evaporation step, which is set at a higher level of vacuum than the previous step. These evaporation temperatures range from 80-100 degrees C. for prolonged periods. In a conventional processing workflow, the end goal at this stage is a brix level of 75-85 brix prior to entering the pan boiling station 116. This is where the product called golden syrup is pulled off (i.e., filtered out or otherwise removed). The golden syrup has a glycemic index of around 65, with the sugar content being approximately sucrose at 27%, and reducing sugars (comprised of glucose and fructose) of around 47%, with ash at 3% and water at 18%.

At this point in a conventional process, the syrup moves into a boiling pan evaporation phase 116 to increase brix and viscosity, before moving on to a crystallization phase 118, where crystallization begins to occur at 95+ brix. After a centrifugation phase 120 to remove the molasses, the crystals contain no or very few remaining nutrients and only sucrose, unless molasses is added back in to make light brown sugar. The crystalized sucrose is then subjected to another heating step 122 for purposes of drying the crystals to under 2% moisture, followed by cooling and conditioning to avoid clumping in the final package.

FIG. 1(b) is a diagram illustrating the types of products that may be derived from the conventional processing of sugar cane, such as the processing pipeline of FIG. 1(a). Note that each one of the refined products illustrated in the figure requires significant heating of the sweeteners (to above 100 degrees C., 212 degrees F., which is boiling at normal atmospheric pressure) to facilitate chemical structural changes in the sugar composition during processing, and for drying before packaging. These heat treatments and their duration causes destruction of some of the nutrients, with the vitamins, enzymes, antioxidants and plant pigments being the most sensitive and typically being damaged or completely destroyed.

A product of the conventional processing pipeline called evaporated sugar or whole cane sugar, non-crystallized sugars are not put in a centrifuge and the molasses is not separated out of the mixture. Instead, the juice from crushed sugar cane stalks is heated and clarified using flocculation chemicals and the liquid is typically open-pan evaporated by boiling until the sugar spontaneously crystallizes at a high moisture content of 80-83+ brix, Usually this forms a solid block after cooling to room temperature in some sort of mold. The resulting sweetener, which retains all molasses and minerals, can be chipped off in chunks or ground into brown granules. Because of its high moisture and molasses content and affinity to absorb water, such whole cane sugars are typically not free flowing and are very difficult to handle in large, industrial-scale applications. For this reason, they are primarily sold in retail stores for direct consumption: examples include products sold or traded locally between villages or sold in traditional retail stores. These “wet” sugars are usually not produced under HACCP or inspected conditions. Depending on the country or place or manufacture, these products have names such as Raparua, Panella, Jaggery, and Moscavado and are not to be confused with the product produced by the system and methods described herein.

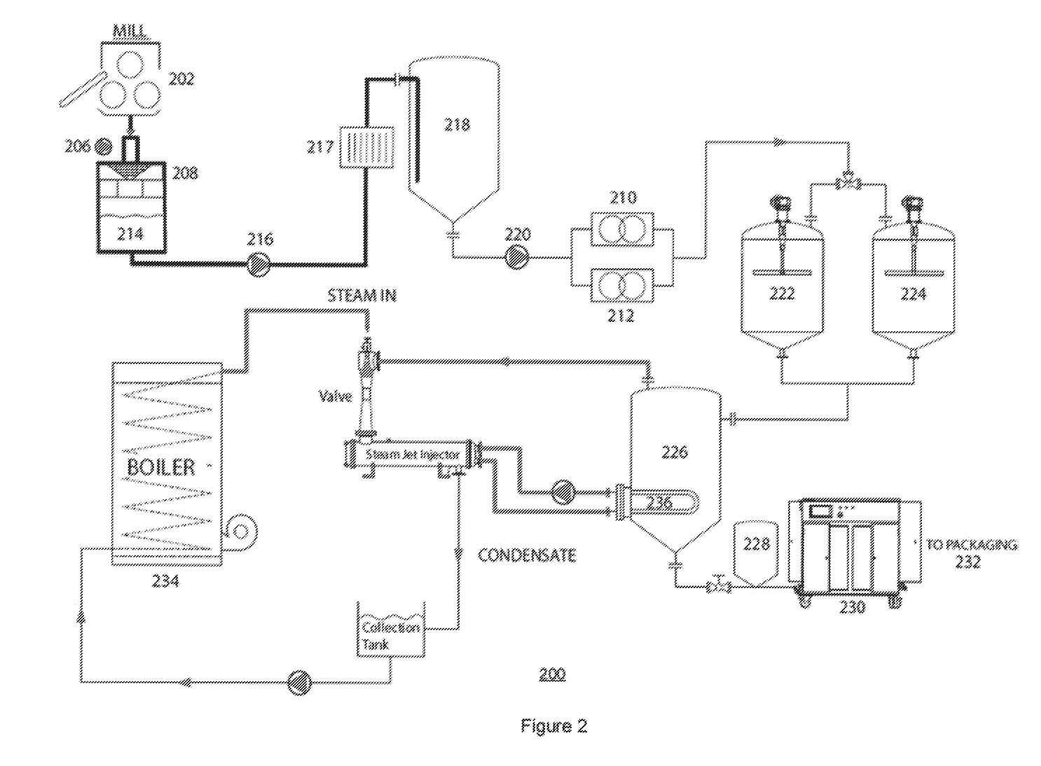

FIG. 2 is a diagram illustrating elements or components of a system and pipeline for processing sugar cane in which an embodiment of the invention may be implemented; more specifically, the figure illustrates the processing pipeline and elements or components of a cold processing system for processing sugar cane into a 60-72 brix syrup. The process is described below with reference to certain elements or components of FIG. 2:
a) Prior to juicing, the cut sugar cane is soaked in a solution of bio-acidifier (e.g., ascorbic acid, citric acid, lemon juice, lime juice, or other natural solution) for 2-4 hours at a concentration of 0.01-0.5% to adjust its pH, which helps to prevent enzymatic browning and degradation of the natural antioxidants present in the cane;
b) The cut raw cane is washed in a pressure washer system with 200 ppm chlorine (or other organic approved biocide) to inhibit bacterial growth;
c) The cane is juiced by being crushed between heavy rollers 202. In a separate process, the resulting bagasse (the fibrous material left over after juicing) is re-washed and re-crushed to remove residual juice—this can recover another 2-3% yield of dilute juice, brix 1-3, which may be added back into the process at the surge tank (note that the re-washing step or stage is not illustrated in the figure);
d) Peristaltic pump 206 delivers a 0.3-2.0% concentration solution of the bio-acidifier (e.g., ascorbic acid, citric acid, lemon or lime juice, or other natural solution) in order to control the pH and maintain it between 3.8-4.2, thereby minimizing the action of polyphenoloxidaze and the destruction of antioxidants, and also preventing/minimizing enzymatic browning. The bioacidifier dosing may be performed/controlled using a continuous pH meter mounted in surge tank 214 that operates to control the peristaltic pump's delivery volume to ensure the same pH juice is entering the process. Examples of other natural buffers are addressed in Patents WO2008106755A1—Pereira Paulo Xavier, Nercio José & WO2017203494A1—Dipin KAPUR, Sachin Goel Neeraj Jalan 2016;
e) The juice then gravity feeds through a 250-micron filter 208 to filter out pieces of bagasse residue and to protect the downstream fine filters, components 210 and 212, from blinding-off prematurely and restricting flow;
f) The juice then accumulates into a jacketed surge tank 214 that has circulated chilled water running through its jacket attached to the cooling system to immediately begin to cool and protect the juice from chemical changes;
g) A positive displacement, vari-drive food grade pump component 216, pulls the rough juice coming from the surge tank 214 and pushes it through a plate heat exchanger 217 with food grade glycol circulating at −2 to −4 degrees C. (25-28 degrees F.) on one side of the stainless plates and cane juice on the other side of the plates (or other form of heat exchanger), to reduce the juice temperature from an estimated 25-30 degrees C. down to 2-4 degrees C.; this cooling slows fermentation and stabilizes/minimizes oxidation of the juice;
h) The balance tank 218 is fitted with high and low level controls, which turns off the juicing rollers 202 and the vari-drive pump 216 if there is a downstream problem and juice backs up, or if the tank reaches the low threshold level, thereby ensuring no raw product overflows and that there is never an empty evaporator. These food grade, stainless level controllers are an electronic device or mechanism and may be chosen based on quality and price and set to generate both audible and/or electronic signal(s) which can page engineers on duty in case of a shutdown or out of specification malfunction;
i) Component 220, a positive displacement food grade vari-drive pump, provides juice from tank 218 to the fine filters 210 and 212, which are sized at 5-100 microns, depending on type of product that is ordered. These filters are used in an alternating manner so the process can continue while one unit is being cleaned. The filters remove smaller organic particles that could settle or float in the final packaging and be visibly undesirable during the post processing shelf life period;
j) After filtration, pump 220 pushes the juice into the cone bottom stainless, jacketed, 500 liter dosing tanks, components 222 and 224 in an alternating manner. These tanks are equipped with agitators for blending, and are jacketed and water-cooled; they serve as flavor or pH adjustment mixing tanks prior to evaporation. The raw juice may be pH adjusted prior to evaporation to standardize the juices; the tanks contain level controls to prevent overflow and running dry;
k) The juice then enters a low temperature (ranging between 37 and 50 degrees C., with a preferred temperature of approximately <40 degrees C.) evaporation tank 226 at 13-15 brix. When evaporation is performed within the 37-50 C range, it is possible to maintain most of the original attributes of the fresh pressed cane juice. For example, attributes retained or preserved during processing in this temperature range include Phenols, Amino acids, antioxidants, vitamins, and minerals. Note that Phenols and antioxidants, along with vitamins C & B, are the most unstable with regards to heat treatment;
l) For an evaporation process conducted at between 35 and 50 degrees C., and operating under a pressure of 28.12 inches of HG at 35 C and 26.28 at 50 C, the resulting product is a syrup between 60-72 brix depending on the customer's needs and the quality of the initial raw materials. The evaporation process may be implemented using a boiler 234, coupled with a steam jet injector which assists in developing the needed vacuum, thereby reducing or eliminating the need for a more expensive liquid ring type vacuum pump, condensate collection tank for returning hot condensed water back to the boiler as pre-heated make up water (thereby reducing energy consumption), and associated pumps between boiler 234 and heating element 236;
m) After reaching the targeted brix level, 60-72 brix, the syrup is pumped into a 250 liter jacketed surge tank 228, prior to entering the cold product protection step, using equipment 230;
   Equipment 230 will be one or a combination of devices such as UV photo purification, HPP high pressure processing, PEF pulsed electrical field, microfiltration, or other device or process referred to herein. The optimal exposure time may be determined for the cold pasteurization equipment may be determined by testing the % reduction in bacteria, yeast and mold in final samples, with a target of a 5 log reduction being a goal. An example of suitable UV product protection equipment may be found in “Sterilization of Liquids Using Ultra-Violet Light” PCT ZA2000/000189, and EP1255444A2, and is specifically designed to be able to process opaque liquids, which was not possible prior to the development of that equipment. The correct circulating exposure time may be determined by allowing syrup to have variable exposure times depending upon Brix levels. The goal is to expose the syrups to photo purification or other cold method for as little time as possible to maintain all initial vitamins, minerals, antioxidants and amino acid concentrations, while minimizing yeast, mold, and bacteria, and thereby achieving a high standard of food safety without the use of high (and potentially damaging) heat;
n) A 60-72 brix syrup is placed in a pre-sterilized bag-in-box packaging 232 under aseptic conditions. The processing pipeline described herein should provide an estimated 12 to 18-month shelf life for the syrup;
   The syrup may be packaged into sterilized brown or green glass liters for retail applications, packed 10 to a box, 15-liter bag-in-box, or 1000-liter bag-in-box recyclable totes that are protected from light.
o) For powder production from syrup, the syrup is evaporated in the low temperature vacuum evaporator to 70 brix, then transferred to a low temperature vacuum belt dryer or spray drier, making a powder with a moisture content below 1.0% and which is not crystalized. Note that normal white sugar is crystalized using high temperatures between 120-125 degrees C.

An important difference between a traditional refined white sugar/molasses production plant (such as that described with reference to FIG. 1(a)) and the innovative “Whole Cane” nutraceutical syrup processing plant (such as that described with reference to FIG. 2) is the focus on preventing nutritional degradation and oxidation or fermentation of the cane-based juice, while maintaining the natural ratio of nutrients occurring in the sugar cane itself. One advantage of this processing pipeline is to produce a nutraceutical syrup containing naturally occurring nutrients that are also sweet; this enables the syrup and products containing the syrup to provide a nutritional benefit while also acting as a sweetening agent having a low-to-medium glycemic index (GI).

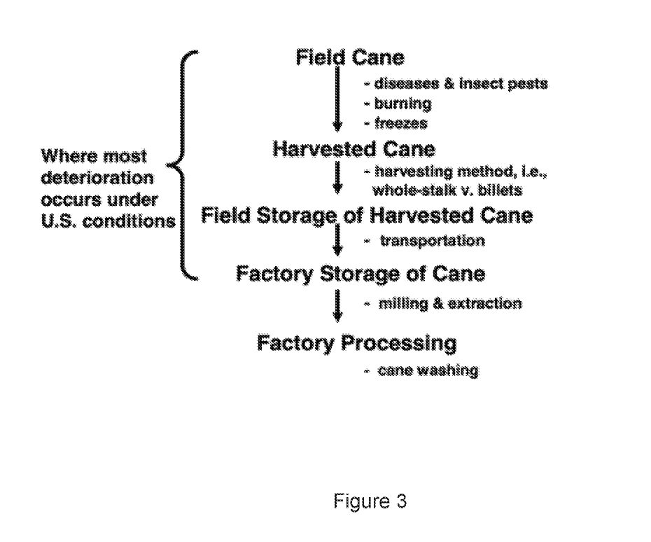

In some implementations, the innovative system may utilize international manufacturing locations near to sugar cane growing fields to ensure freshness. In some implementations, the innovative system and processes include juicing and evaporating within 6-24 hours (or as soon as is practical) after cutting the cane to ensure a fresh juice that has not begun to significantly ferment, or oxidize, has minimized reducing sugar development (that is, glucose and fructose), and preventing off-flavors or compromised nutritional traits. FIG. 3 is a chart which indicates aspects of the conventional cane processing pipeline at which deterioration may occur. Note the indication of both the stage of the processing pipeline and the cause or causes of deterioration associated with that stage for each of the multiple stages.

Benefits, advantages, and aspects of embodiments of the system and methods described herein include one or more of the following:
a) a relatively low-to-medium glycemic index syrup, produced using non-traditional processing protocols that include maintaining processing temperatures in a range between 37 and 50 degrees C. (with a preferred value of approximately 40 degrees C.), in order to maximize the functionality of the natural nutrition in the sugar cane. In this regard, note that the GI separates carbohydrate-containing foods into three general categories:
   i. High Glycemic Index Foods (GI 70+) causing a rapid rise in blood-glucose levels;
   ii. Intermediate/Medium Glycemic Index Foods (GI 56-69) causing a medium rise in blood-glucose; and
   iii. Low Glycemic Index Foods (GI 55 or less) causing a slower rise in blood sugar.
b) a syrup that contains naturally occurring plant pigments (a source of beneficial nutrients);
c) a syrup containing naturally occurring nutrients in their native (or close to) ratios, including enzymes, vitamins, trace minerals, antioxidants and plant pigments. Note that sugarcane contains various phytochemicals including phenolic compounds, plant sterols, and policosanols;
d) a syrup using no processing chemicals aside from those used for natural pH adjustment (such as lemon or lime juice, ascorbic acid, citric acid, or other natural source);
e) a syrup that may be used as part of high-value applications and formulas, including (but not limited to) medical syrups, pharmaceutical low-to-medium GI applications, cosmeceutical, mediums to transport vitamins, minerals, cough syrups, elixirs, and use as a fermentation substrate for companies who prefer chemical-free or certified organic growing mediums;
f) a market focus on sourcing organic and/or sustainable grown cane;
g) to replace traditional refined cane syrup product uses in the medical field, or in medical or foods for diabetic consumers; and
h) utilizing one or more of UV photo purification, HPP high pressure processing, PEF pulsed electrical field, microfiltration, or other device or process referred to herein to perform a cold (below 40 degrees C.) pasteurization step, thereby eliminating spoilage organisms.

Note that by offering a nutrient-dense bacteriologically clean syrup or powder, the innovative system and methods are capable of supplying a unique product into the medical and pharmaceutical fields; this product is provided in a familiar syrup or powder delivery system that contains significant nutrients and provides a potentially lower GI product depending on the formula, while delivering an acceptable sweet flavor (with roughly a 1-to-1 replacement ratio with respect to other sweetening syrups, which is an aspect that is highly desirable).

Possible product applications for the innovative syrup and powder may include:
Low GI medical foods;
glucose delivery systems;
as a carrier for liquid vitamins, minerals, pre and probiotics taken orally;
cough syrup;
fermentation mediums for the production of enzymes, and biological substances;
beverages, candy/confectionary, cereal, coffee & vending;
condiments, sauces & dressing;
convenience foods;
dairy, yogurt, drinks;
fillings;
foods targeting diabetic consumers;
frozen ice cream and novelties;
gelatin, icing/glaze, jam/jelly, mixers;
snacks
cosmetics

In addition to other benefits, embodiments of the low temperature process described herein produce a unique 13-15 brix cane juice, a 60-72 brix cane syrup, and a dried powder that each have superior nutritional qualities over any refined or natural sweeteners. As realized by the inventor, the “cold” process described herein not only provides an improved sweetener or sweetening agent, but also a nutrient dense nutraceutical syrup or powder for use in a number of applications or contexts, from food, to candy, to cosmetics, pharmaceuticals, to medicine.

Embodiments of the system and processing pipeline described herein eliminate the need for process chemicals and severe heat treatments, and may be used to produce (in some embodiments) a signature greenish colored syrup with the majority of nutrients naturally found in the cane plant (Saccharin officinarum L) still intact, highly bioavailable, and in their natural ratios to each other. This provides an alternative sweetener and a unique functional ingredient for use in applications where the manufacturer may want to increase the overall nutrient content for a manufactured food, thereby allowing them to make specific label health claims. As understood by the inventor, the described system and processing pipeline represent the first process that addresses the production of cold processed whole cane syrup without harsh chemicals, and provides an ability to maintain nutrient quality, quantity, good taste and odor.

As noted, embodiments of the low temperature process described herein are intended to minimize nutrient damage by reducing processing temperatures in all phases below the range of 37 to 50 degrees C., and eliminating the use of the processing chemicals used in producing refined sugar. This approach preserves the nutritional value of a wide range of nutrients that are normally destroyed by the relatively high temperatures used in conventional processing pipelines. The result is to produce a nutraceutical product containing vitamins B1, B2, B3, B5, B6 minerals, iron, calcium, chromium, cobalt, copper, magnesium, manganese, phosphorous, potassium, and zinc, along with antioxidants including polyphenols such as Apigenis, Tricin, Luteolin, and Cinnamic acid in their respective amounts and proportions as would be found in raw sugar cane. The combination of low temperature processing, pretreatment of the cane (soaking in a bio-acidifier solution), the pH adjustment of the cane juice using a bio-acidifier (e.g., lime juice, lemon juice, ascorbic acid, citric acid, other natural solution, etc.), and the cold processing temperatures can also slow down the enzymatic browning reaction that is catalyzed by Polyphenoloxidase (PPO) and Peroxidase (POD).

Syrups are a concentrated solution of a sugar mixed in water or other aqueous liquid. In medical terminology, medicinal syrups or syrups are nearly saturated solutions of sugar in water in which medicinal substances or drugs are dissolved; basically, it is an oral suspension in liquid form where the medical syrup or pharmaceutical syrup is used as a vehicle for the delivery of medicine. It is usually used as a flavored vehicle for drugs. Syrups should be kept closely tight in a cool, dry place after use in order to preserve them.

Medicinal syrups are widely consumed as children medicines, though medicated syrups for adults are also available. In general, there are various medicinal syrups such as cough syrups, iron syrups, calcium syrups, syrups for digestion, anti-allergy syrup, anti-fever syrup and so on that may benefit from use of the processing pipeline and its end products described herein. Some of the most popular medicated syrups are given in the list below; there are many medicines which are available in both tablet and syrup forms.
Ambroxol
Amoxicillin
Bromhexine
Cefpodoxime Proxetil
Cefixime
Cefadroxil
Cephalexin
Cefuroxime
Paracetamol
Chlorpheniramine Maleate
Dextromethorphan
Erythromycin
Ephedrine/Guaifenesin Syrup
Iron Tonic
Multivitamins
Cefaclor
Salbutamol
Cetirizine Hydrochloride
Protein Powder
Cloxacillin
Pseudoephedrine
Clarithromycin
Phenylephrine
   Elixirs: A clear, sweetened, hydro-alcoholic liquid intended for oral use; elixirs contain flavoring substances and are used either as vehicles or for the therapeutic effect of the active medicinal agents.
   Cosmetics: Polyphenols are plant compounds with high anti-oxidative activity making them attractive as ingredients for cosmetics. The chemical structure of polyphenolic compounds causes their reducing properties, which allow them to act as antioxidants and free radical scavengers.

Note that aligning with the work of Dr. Kannar (Kannar and Kitchen, 2016), it is contemplated within the scope of the Whole Cane processing pipeline and its products that the process and/or resulting products may be incorporated into various conventional pharmaceutical and cosmeceutical preparations and dosage forms, such as tablets (plain and coated) for use orally, bucally and sublingually, capsules (hard and soft, gelatin, with or without additional coatings), powders, granules (including effervescent granules), pellets, micro particulates, solutions (such as micellar, syrups, elixir and drops), lozenges, pastilles, ampoules, emulsions, micro emulsions, ointments, creams, suppositories, gels and transdermal patches, other transdermal delivery methods.

The present invention may also be impregnated, mixed, emulsified, sprayed or coated onto carriers such as cellulose, methycellulose, dextrose, cyclodextrose, cyclodextrin, maltitol, fiber and fiber containing bioactives to improve delivery. Delivery may also be enhanced with a range of surfactants, lipids, complexes, solvents and co-solvents pharmaceutical delivery systems know in the pharmaceutical art to improve bioavailability, absorption and efficacy. For reference, see (1) Kannar, D and Kitchen, J. B. 2016. U.S. Pat. No. 9,364,016 B2, and (2) Zillich, O. V., Schweiggert-Weisz, U., Eisner, P. and Kerscher, M. 2015.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method for processing sugar cane, comprising:
soaking the raw cane in a first bio-acidifier solution prior to juicing;
juicing the soaked raw cane to produce raw cane juice;
conditioning the juice, brix 13-15 to a pH of between 3.8 to 4.5 by adding an amount of a second bio-acidifier solution;
passing the conditioned raw cane juice through a cooling component to reduce the temperature of the raw cane juice to between 2 and 4 degrees C.;
subjecting the cooled raw cane juice to an evaporation step, wherein the evaporation step temperature is maintained within a range of 37 to 50 degrees C. until the Brix value reaches 60-72 Brix;
subjecting the output of the evaporation step to a process to prevent degradation from microbiological activity; and
packaging the output of the cold product protection process.

2. The method of claim 1, wherein the first and second bio-acidifier solutions consist of lime juice, lemon juice, citric acid, ascorbic acid, or other natural solution.

3. The method of claim 2, wherein the raw cane is soaked in the bio-acidifier solution for a period of between 2 to 4 hours, and the solution contains a concentration of between 0.01-0.5% of the lime juice, lemon juice, citric acid, ascorbic acid, or other natural solution.

4. The method of claim 1, wherein the juicing of the soaked raw cane is performed using a mill.

5. The method of claim 1, wherein the raw cane juice is conditioned by adding the bio-acidifier solution until the pH reaches a value between 3.8-4.2, and the solution contains a concentration of between 0.3-2% of the lime juice, lemon juice, citric acid, ascorbic acid, or other natural solution.

6. The method of claim 1, wherein the cooling component is a heat exchanger.

7. The method of claim 1, wherein the process to prevent degradation from microbiological activity is performed using one of UV photo purification, HPP high pressure processing, PEF pulsed electrical field, or microfiltration.

8. The method of claim 7, wherein the UV photo-purification process includes exposing the output of the evaporation process to UV-C radiation.

9. The method of claim 1, wherein the output of the process to prevent degradation from microbiological activity is a syrup having nutritional components in substantially the natural relationships and ratios as would occur in the unprocessed sugar cane.

10. The method of claim 9, wherein the nutritional components include one or more of iron, calcium, magnesium, potassium, B-vitamins, trace minerals, enzymes, and antioxidants.

11. The method of claim 1, further comprising evaporating the output of the process to prevent degradation from microbiological activity to a value of 70 brix as a preliminary step to produce a dry powder.

12. The method of claim 11, wherein the evaporation which produces the powder is performed by a low temperature vacuum belt dryer or spray drier.

13. The method of claim 1, wherein the evaporation step temperature is approximately 40 degrees C.

14. A system for processing sugar cane, comprising:
a container for soaking the raw cane, the container including a first bio-acidifier solution;
a juicing element for juicing the soaked raw cane to produce raw cane juice;
a container for conditioning a pH of the raw cane juice, brix 13-15, to a pH of between 3.8 to 4.5 by adding an amount of a second bio-acidifier solution;
a cooling element operative to reduce the temperature of the raw cane juice to between 2 and 4 degrees C.;
an evaporator for subjecting the cooled raw cane juice to an evaporation process, wherein the evaporation process temperature is maintained within a range of 37 to 50 degrees C. until the Brix value reaches 60-72 Brix;
a processing element for protecting the output of the evaporator from degradation from microbiological activity; and
a packager for packing the output of the cold product protection process.

15. The system of claim 14, wherein the first and second bio-acidifier solution are each one or more of lime juice, lemon juice, citric acid, ascorbic acid, or other natural solution.

16. The system of claim 14, wherein the processing element for protecting the output of the evaporator from degradation from microbiological activity uses one of UV photo purification, HPP high pressure processing, PEF pulsed electrical field, or microfiltration.

17. The system of claim 16, wherein the photo-purification process includes exposing the output of the evaporation process to UV-C radiation.

18. The system of claim 14, wherein the juicing element for juicing the soaked raw cane to produce raw cane juice is a mill.

19. The system of claim 14, wherein the evaporation process temperature is approximately 40 degrees C.

20. The system of claim 14, further comprising a second evaporator for evaporating the output of the processing element for protecting the output of the evaporator from degradation from microbiological activity to produce a powder.
